(19) United States
(12) Patent Application Publication
(10) Pub. No.: US 2007/0074132 A1
(43) Pub. Date: Mar. 29, 2007

(54) Method and system for supporting a function call via a user interface

(76) Inventors: Anja Bluhm, Feucht (DE); Juliane Rettner, Nurnberg (DE); Markus Weinlander, Happurg (DE); Helmut Windl, Peisig (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/527,207

(22) Filed: Sep. 26, 2006

(30) Foreign Application Priority Data
Sep. 26, 2005 (EP) 05020956.8

(51) Int. Cl. G06F 17/00

(52) U.S. Cl. 715/823

(57) ABSTRACT

In accordance with one aspect, a method for supporting a function call in an operating system is specified. In this method, a function call triggered by the user is first determined and checked by the system to determine whether an object is selected for the application of the function. In addition, information is made accessible to the user if no object is selected; if an object is selected, a check is carried out to determine whether it is suitable for the application of the function; and if an object is selected which is not suitable for the application of the function, information relating thereto is made accessible to the user.

### CROSS REFERENCE TO RELATED APPLICATIONS

This application claims priority of European application No. 05020956.8 EP filed Sep. 26, 2005, which is incorporated by reference herein in its entirety.

### FIELD OF INVENTION

The invention relates to a method and a system for supporting a function call by means of a user interface, by way of which a user communicates with an electronic data processing system.

### BACKGROUND OF INVENTION

A user interface generally represents a human-machine interface, by means of which a user (human) can interact with an operating system/a computer (machine) by way of the user interface. A distinction is made between two types of user interface: on the one hand function-oriented user interfaces and on the other hand object-oriented (or graphic-oriented) user interfaces. With function-oriented user interfaces, it is imperative that the user inputs and confirms the individual commands/functions. In contrast, with object-oriented user interfaces, it is not imperative that the commands are input, but instead corresponding commands can be executed by manipulating objects. A typical example of this is the Windows operating system.

In a development system, an object-oriented approach is generally followed, since for technical reasons it is first necessary to select the relevant objects for very many functions. For example, the user must thus first determine for a function, for which objects and/or how the function is to be executed.

Some users, above all novices, are not familiar with the principle of object-oriented interaction for all functions. Operability tests have shown that functions, such as for instance “opening” or “copying”, are found by way of object-oriented interaction, but other functions such as “download” or “compile” are instead expected to be function-oriented.

With a purely object-oriented approach, specific functions in the menu/context menu or on the toolbar are only available if corresponding objects were selected. Otherwise the function is not offered or is denoted “disabled”, generally grayed out. If the user does not know whether or why the selection of an object for this function is not suitable, he is also unable to gain any assistance. A user interface of this type is less user-friendly and can require a long period of familiarization, because another command or suitable object must be consulted.

### SUMMARY OF INVENTION

An object underlying the invention is to support calling a function of an electronic data processing system, in particular a computer.

This object is achieved in accordance with the invention by a method and a system with the features of the claims. In order to support the function call, the system checks whether an object was selected for the application of the function. Furthermore, information relating thereto is made accessible to the user.

The advantages achieved with the invention consist in particular in simpler operation/use, above all for novices and/or users who are upgrading, thereby allowing lower initial thresholds and/or a simpler process of familiarization. This method is easy and intuitive to learn and is geared to the conditions pertaining to a function call.

A user interface is an interface and/or user interface, by way of which a user can communicate with an electrical data processing system, e.g. a computer. In accordance with the invention, a method for supporting the call of functions in a system of this type is specified. In this method, a function call triggered by a user is determined by the system and then checked to determine whether an object has already been selected for the application of the function. In addition, information is made available to the user if no object is selected. If an object is selected, a check is carried out to determine whether it is suitable for the application of the function, and if an object which is unsuitable for the application of the function is selected, the corresponding information is made accessible to the user. If an object which is suitable for the application of the function is selected, the function can be implemented.

As with conventional object-oriented user interfaces, the function can be implemented by the user without any further inputs, if the user has selected an object which is suitable for the application of the function prior to calling the function. If only objects which are suitable for the application of the function are selected, the function can be immediately implemented.

If the user has selected several objects prior to the function call, and not all are currently suitable for this function, it is then advantageous either to issue the user with feedback as to which of the selected objects are currently suitable for this function, or to immediately implement the function with these objects. An explanation is then given to the user as to why the remaining objects selected by him/her are not suitable and how he/she can, if necessary, enable the use of the function using these remaining objects.

If there is no object currently suitable for the application of the function available, information relating thereto can be output.

Aside from the above-illustrated method, the invention also comprises a device and/or a system, by way of which the method can be implemented.

With the system, no further hardware components are needed; it can be realized by software alone.

The dependent claims contain further advantageous embodiments.

### BRIEF DESCRIPTION OF THE DRAWINGS

The invention is described in further detail below in the context of an exemplary embodiment with the aid of figures, in which:

FIG. 1: shows an example of an object-oriented user interface

FIG. 2: shows an example of a user interface used in an inventive function call support.

### DETAILED DESCRIPTION OF INVENTION

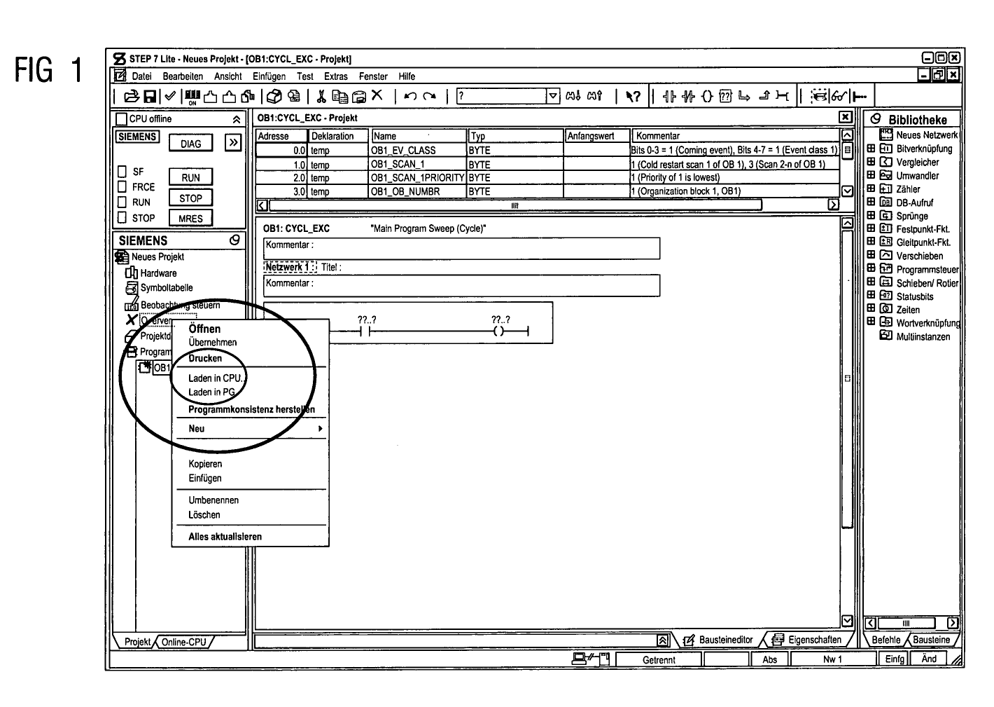

FIG. 1 shows a function call “Load in CPU”, with an object-oriented user interface. If the user has not selected any loadable object, the function cannot be called up or locked, and is, as indicated in FIG. 1 in the region marked by a cross, characterized by being displayed (e.g. in gray compared with the functions which can be implemented, which are displayed in black) as non-implementable. There is no possibility here for the user to gain any assistance, e.g. to determine whether or why the selection of the object is not suitable for this function.

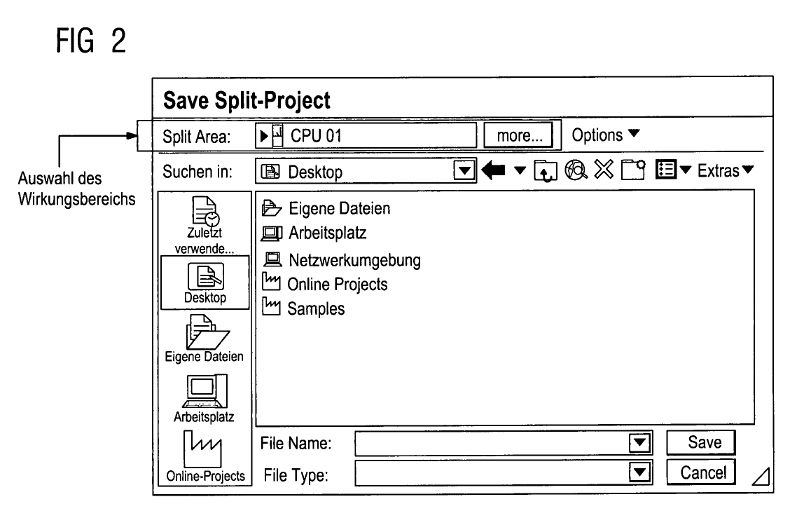

One example of a method according to the invention is specified as follows, with the function “Save as” being called up. If the user has selected an object consistent with this function, and has then called up the function, this function is implemented immediately, i.e. without any further operating steps by the user. This is identical to the object-oriented approach. If no object is selected or an unsuitable object is selected, a pop-up window, and/or an additional pushbutton appear, which offers a suitable selection of the sphere of action, e.g. sphere of action CPU 01 in FIG. 2. If the user has selected several objects, some of which are not suitable for this function, those selected objects, which support the function, are preselected (marked) in the above-mentioned pop-up window. It is thus possible to save the suitable objects in the sphere of action CPU 01 (i.e. to implement the function), in that a corresponding command is simply entered.

1.-8. (canceled)

9. A method for supporting a function call of an electronic data processing system, comprising:
determining the function call triggered by a user;
checking if an object is selected for an application of the function;
providing information about a missing selection of an object when the results of the selection checking indicates no object is selected;
checking if the selected object is suitable for the application of the function when the results of the selection checking indicates an object is selected; and
providing information about the selection of an unsuitable selected object when the results of the suitability checking indicate the selected object is unsuitable.

10. A method as claimed in claim 9, wherein the function is executed when the selected object is suitable.

11. A method as claimed in claim 10, wherein the function is executed immediately.

12. A method as claimed in claim 10, further comprising providing corresponding information to the user when no object suitable for the application of the function is currently available.

13. A method as claimed in claim 10, further comprising providing corresponding information to the user if no object is selected or the selected object is unsuitable.

14. A method as claimed in claim 13,
wherein a plurality of objects are selected,
wherein at least one of the plurality of objects is unsuitable and at least one of the plurality of objects is suitable, and
wherein additional information is provided to the user indicating the suitable objects.

15. A computer program for a system that supports a function call and a user interface, the computer program when executed executes the method comprising:
determining a call of a function triggered by a user;
checking if an object is selected for an application of the function;
providing information about a missing selection of an object when the results of the selection checking indicates no object is selected;
checking if the selected object is suitable for the application of the function when the results of the selection checking indicates an object is selected; and
providing information about the selection of an unsuitable selected object when the results of the suitability checking indicate the selected object is unsuitable.

16. A program as claimed in claim 15, wherein the function is carried out when the selected object is suitable.

17. A program as claimed in claim 16, further comprising providing corresponding information to the user:
when no object suitable for the application of the function is currently available,
when no object is selected or
when the selected object is unsuitable.

18. A program as claimed in claim 17,
wherein a plurality of objects are selected;
wherein at least one of the plurality of objects is unsuitable and at least one of the plurality of objects is suitable, and
wherein additional information is provided to the user indicating the suitable objects.
